(19) United States
(12) Patent Application Publication
(10) Pub. No.: US 2008/0258064 A1
(43) Pub. Date: Oct. 23, 2008

(54) RADIATION RATE METER DISPLAYING REMAINING TIME PARAMETERS

(76) Inventor: Stephen Anthony Cima, San Antonio, TX (US)

Correspondence Address: RAMAN N. DEWAN;JACKSON WALKER, L.L.P., 100 CONGRESS AVENUE, SUITE 1100, AUSTIN, TX, 78701, US

(21) Appl. No.: 11/738,799

(22) Filed: Apr. 23, 2007

(51) Int. Cl. G01T 1/00

(52) U.S. Cl. 250/336.1

(57) ABSTRACT

A dosimeter includes a radiation detector and a display. The radiation detector outputs a signal indicative of an instantaneous radiation level. The dosimeter determines and displays a percent of limit (POL) value and/or a time to limit (TTL) value. The POL value indicates a ratio of an accumulated exposure to an exposure threshold. The TTL value indicates an amount of time estimated until the accumulated exposure exceeds the exposure threshold. The display may includes information indicative of both the POL parameter and the TTL parameter. The display may also display the instantaneous radiation level and/or a graphical representation of the instantaneous exposure level. The graphical representation might include a set of LED's arranged in a line wherein the number of activated LED's indicates the instantaneous exposure level. The display might also indicate a scale associated with the set of LED's. The dosimeter might include a switch to select one of multiple operational modes where the POL parameter and the TTL parameter are determined in part by the operational mode.

### BACKGROUND

1. Field of Invention

The invention relates to radiological instruments and, more particularly, to radiological instruments used by security, fire-fighting and explosive ordnance disposal personnel to monitor and control radiation doses to which such personnel are exposed.

2. Description of Related Art

The term “radiation” as used herein refers to any type of ionizing radiation of various energies and intensity. The term “dirty bomb” relates to an explosive device that contains any type of radioactive isotope. The term “radiological instrument” as used herein refers to any instrument that measures the intensity of a radiation field in units of exposure, absorbed dose, dose-equivalent, or any other units that can be related to a dose limit prescribed for personnel.

Radiological instruments are used in medicine, industry, and research for dosimetry, imaging, and for homeland security applications. Personnel tasked with responding to radiological emergencies, including actual or suspected dirty bombs, use a wide assortment of radiological instruments capable of detecting and measuring various types of radiation over a wide range of radiation intensities. For homeland security purposes, radiological instruments have been issued to security, fire-fighting, explosive ordnance disposal, and other response personnel and agencies.

The most basic radiological instruments display only the current radiation dose-rate. Most modern instruments also function as a dosimeter, integrating the dose-rate to record and display the accumulated dose. See, e.g., commercially distributed dosimeters including the MGP DMC 2000S model of electronic dosimeter from Arrow-Tech, Inc. Dose and dose-rates are typically displayed using prefixes such as “m” for milli or “u” for micro. Users of radiological instruments maintain their radiation doses within prescribed dose limits by calculating the fraction of the dose limit they have received and how much time they have before the dose limit will be reached. Properly performing these calculations requires familiarity with radiological units and prefixes and the mathematical formulas involved.

Personnel entering radiation fields usually have radiation dose limits prescribed by appropriate authorities to ensure the radiation dose received will not inappropriately endanger their health and safety. The dose limits depend on the situation. For example, the dose limits for lifesaving activities are typically greater than those for normal operations. Still higher dose limits can be established for dire emergency situations.

Personnel must know the dose limit applicable to their situation. Receiving more radiation than the prescribed limit endangers the health and safety could be endangered. On the other, if response personnel are overly cautious and unnecessarily refrain from entering or remaining in radiation fields, their ability to perform their response functions could be diminished.

Some procedures for disarming dirty bombs call for rotating explosive ordnance disposal technicians to ensure each technician's dose remains within prescribed limits. The disarming activities may be completed in discrete stages, with the rotation of the technicians preferably occurring only at the completion of a stage. At the end of each stage the technicians need to know how much time they before they will reach their dose limit to know if they should begin the next stage or rotate out.

Some procedures for disarming dirty bombs call for first measuring radiation levels around the device and using the measured levels to determine an acceptable stay-time for the explosive ordnance disposal technicians. During the disarming of the device, the technician may move into higher radiation fields than were measured during the survey or may increase the radiation levels by disassembling the device. This could result in the technicians exceeding their radiation dose limits.

During radiological emergencies and practice exercises emergency response personnel have misinterpreted their radiological instrument's readings, improperly calculated the time remaining until they will reach their dose limit, or used improper dose limits for the situation. These failures are unsurprising since emergency responders are generally unfamiliar with radiological units and prefixes and have never encountered measurable radiation fields.

There are many radiological instruments developed or presented, including those covered by the reference patents. All of the existing radiological instruments display the radiation dose-rate or accumulated dose in terms of radiological units. This invention provides a unique approach by displaying the radiation dose-rate and accumulated radiation dose in terms of their operational significance rather than as radiological units. This invention will increase the ability of response personnel to safely and effectively respond to radiological emergencies.

### SUMMARY

In one aspect, a dosimeter includes a radiation detector and a display. The radiation detector outputs a signal indicative of an instantaneous radiation level. The dosimeter determines and displays a percent of limit (POL) value and/or a time to limit (TTL) value. The POL value indicates a ratio of an accumulated exposure to an exposure threshold. The TTL value indicates an amount of time estimated until the accumulated exposure exceeds the exposure threshold. The display may includes information indicative of both the POL parameter and the TTL parameter. The display may also display the instantaneous radiation level and/or a graphical representation of the instantaneous exposure level. The graphical representation might include a set of LED's arranged in a line wherein the number of activated LED's indicates the instantaneous exposure level. The display might also indicate a scale associated with the set of LED's. The dosimeter might include a switch to select one of multiple operational modes, e.g., emergency mode, normal mode, disaster mode, where the POL parameter and the TTL parameter are determined in part by the operational mode.

In another aspect, a radiation monitoring service includes providing a dosimeter having a radiation detector and a display. The radiation detector outputs a signal indicative of an instantaneous radiation level. The dosimeter determines and displays a percent of limit (POL) value and/or a time to limit (TTL) value. The POL value indicates a ratio of an accumulated exposure to an exposure threshold. The TTL value indicates an amount of time estimated until the accumulated exposure exceeds the exposure threshold. The display may includes information indicative of both the POL parameter and the TTL parameter. The display may also display the instantaneous radiation level and/or a graphical representation of the instantaneous exposure level. The graphical representation might include a set of LED's arranged in a line wherein the number of activated LED's indicates the instantaneous exposure level. The display might also indicate a scale associated with the set of LED's. The dosimeter might include a switch to select one of multiple operational modes, e.g., emergency mode, normal mode, disaster mode, where the POL parameter and the TTL parameter are determined in part by the operational mode.

### BRIEF DESCRIPTION OF THE DRAWINGS

Aspects of one or more embodiments are illustrated, by way of example and not limited by the accompanying drawings, in which like references indicate similar elements, and in which:

FIG. 1 is a block diagram of selected elements of an embodiment of a detection device;

FIG. 2 is a conceptual representation of selected modules stored or embedded in a storage medium of the detection device of FIG. 1;

FIG. 3 is an exemplary illustration of an embodiment of a display element of the detection device of FIG. 1;

FIG. 4 is a flow diagram of an exemplary implementation of a method of operation for the detection device of FIG. 1; and

FIG. 5 is a flow diagram showing details of an exemplary implementation of a detect and display module of the method of operation of FIG. 5;

Although aspects of the one or more exemplary embodiments illustrated are described in detail herein, the depiction and description of these aspects does no limit the invention to the particular embodiment disclosed. To the contrary, the claims are intended to encompass, for example, all equivalent and alternative aspects and embodiments that would occur to one of ordinary skill in the art having the benefit of this disclosure.

Elements in the drawings may be presented for simplicity and clarity and may not been drawn to scale. For example, the dimensions of some of the elements in the drawings may be exaggerated relative to other elements to clarify or improve the understanding of the embodiments of the present invention. Block diagrams and flow diagrams may include only selected elements of a depicted embodiment.

### DETAILED DESCRIPTION

In one aspect, a dosimeter including a radiation detector or display is described. The dosimeter is suitable for use by first responder to the scene of an emergency or disaster. The radiation detector is preferably operable to output a signal indicative of a radiation level. The dosimeter is preferably operable to determine and display a percent-of-limit (POL) value, a time-to-limit (TTL) value, or both. The POL value reflects a ratio of a user's accumulated exposure to an exposure threshold. The accumulated exposure value may represent the cumulative amount of radiation to which the user has been exposed. The exposure threshold may represent a threshold level of radiation beyond which exposure to the user may be hazardous. The user might, for example, be a first responder to the scene of a disaster or other emergency.

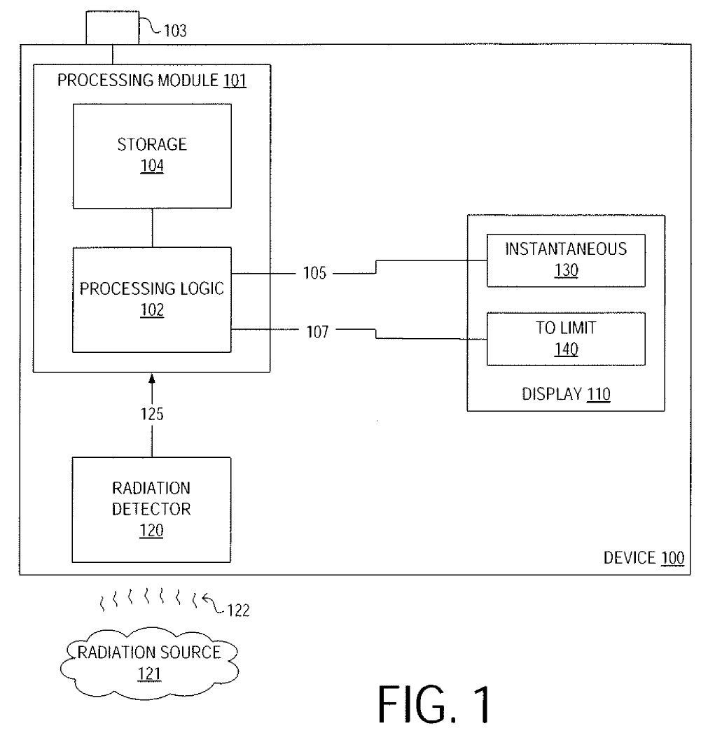

Turning now to the drawings, FIG. 1 depicts selected elements of an embodiment of a dosimeter device 100. Device 100 as depicted includes a processing module 101, a radiation detector 120, and a display 110. In other embodiments, radiation detector 120 may be an external unit that is not part of device 100. The depicted implementation of processing module 101 includes processing logic 102 and storage 104 that is accessible to processing logic 102. Processing logic 102 may represent one or more integrated circuits including, for example, a commercially distributed microprocessor, microcontroller, embedded controller, or the like. Processing logic 102 may also include a field programmable gate array or other form of programmable hardware. Storage 104 may include persistent or non-volatile storage such as a flash memory or other form of programmable read only memory. Storage 104 may also include nonvolatile storage such as an array of static or dynamic random access memory. In some implementations, for example, a non volatile portion of storage 104 may include software code that is executable by processing logic 102.

Radiation detector 120 is preferably operable to detect and measure levels of radioactive energy, represented by reference numeral 122, emanating for a radioactive source 121 in proximity to device 100. Detector 120 is preferably operable to produce an analog or digital signal, referred to herein as radiation signal 125, that is indicative of the detected level of radiation. In some embodiments, detector 120 may further include an accumulation or integration module (not depicted) that is operable to determine a cumulative amount of radiation detected during a specific time interval. In other embodiments, radiation accumulation or integration functionality is delegated to processing module 101. An accumulator may, for example, be implemented as hardware within processing logic 102, software code within storage 104, or a combination thereof.

In the depicted implementation of device 100, processing module 101 communicates with display 110. The depicted embodiment of display 110 includes an instantaneous display module 130 and a “to-limit” display module 140. As its name implies, instantaneous display module 130 preferably displays instantaneous levels of radiation detected by radiation detector 120. As discussed in greater detail below, the “to-limit”: display module 140 preferably displays one or more parameters that indicate directly, without further calculation or manipulation by the user, how close the user is to exceeding a limit or threshold value of exposure.

As depicted in FIG. 1, processing module 102 receives radiation signal 125 from radiation detector 120. Radiation signal 125 may be an analog or digital signal provided over a serial or parallel communication link. The communication link may be wireless or wired. In any event, processing module 101 receives radiation signal 125 and uses radiation signal 125 to provide one or more signals, including instantaneous signal 105 and to-limit signal 107 to display 110.

In embodiments where radiation signal 125 is an analog signal, processing logic 102 preferably includes analog-to-digital (A/D) circuitry capable of converting radiation signal 125 to a digital signal for further processing. In other cases, A/D circuitry is incorporated within radiation detector 120 and radiation signal 125 is a digital signal. In either case, radiation signal 125 is preferably indicative of the instantaneous level of radiation in proximity to radiation detector 120. Radiation signal 125 may also be indicative, in some embodiments, of other measures of radiation levels. For example, radiation detector 120 may be operable to produce a radiation signal 125 indicative of a time-averaged level or radiation over a specified duration. As another example, radiation detector 120 may be operable to produce, as part of radiation signal 125, information indicative of an accumulated level of radiation over a specified duration. In other implementations desirable for lower cost, radiation signal 125 produced by radiation detector 120 may simply be an analog signal that indicates the instantaneous level of radiation.

Where radiation detector 120 merely indicates instantaneous radiation levels, processing module 101 is operable to accumulate radiation signal 125 to determine an accumulated measure of exposure for specific period of time. Device 101 may include a reset button 103 that is operable to clear or initiate the accumulated value and thereby start an accumulation period. As suggested previously, the radiation accumulation functionality of processing module 101 may be implemented with hardware in processing logic 102, software in storage 104, or a combination thereof.

As depicted in FIG. 1, processing logic 102 provides instantaneous signal 105, which is indicative of the instantaneous radiation level, to instantaneous display module 130 of display 110. Processing logic 102 as depicted further provides a to-limit signal 107 to a to-limit module 140 of display unit 110. Whereas instantaneous signal 105 may be derived from radiation signal 125 with little, if any, processing by processing module 101, to-limit signal 107 is preferably indicative of radiation values that cannot be derived by processing module 101 without information in addition to the instantaneous radiation level.

In preferred embodiments, for example, processing module 101 is operable to provide a to-limit signal 107 that indicates an estimate of the time remaining until the user's accumulated exposure exceeds a specified exposure threshold, i.e., the TTL value. As another example, processing module 101 is operable to provide a to-limit signal 107 that indicates a ratio of the user's accumulated exposure to the exposure threshold, i.e., the POL value. In both of these examples, information in addition to radiation signal 125 is required to derive the appropriate signal.

More specifically, processing module 101 derives the exemplary to-limit values referred to above by first accumulating, or integrating over time, radiation signal 125 to produce a cumulative exposure value. Processing module 101 may then retrieve an exposure threshold from storage 104. Processing module 101 then computes the POL value as the ratio of the accumulated exposure to the retrieved exposure threshold. To determine a TTL value, processing module 101 must first determine an estimate of the expected level of exposure. The expected level of exposure might, as an example, represent the average value of exposure experienced during a specified time interval. Other techniques or models for estimating the expected level of exposure may be used as well. The TTL value may then be determined by dividing the difference between the exposure threshold and the accumulated exposure by the estimate of the expected exposure level.

Device 100 may incorporate two or more sets of exposure thresholds for a give user where one set of exposure threshold is used in a less critical environment and another set is used for a more critical environment. In addition, device 100 may incorporate different sets of limits for individuals having different characteristics. As an example, different sets of limits may be selected depending on the user's age, weight, gender, or other characteristic, health status including, for example, whether the user is pregnant. In other embodiments, the radiation limit for a given situation or environment is uniform without regard to the user's characteristics.

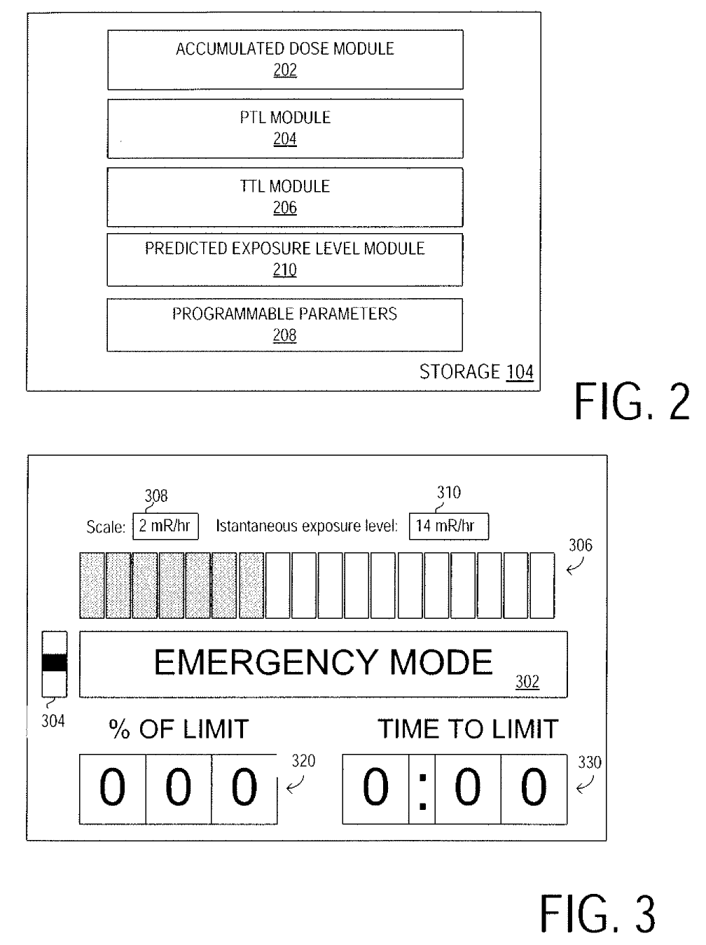

Referring now to FIG. 2, a conceptual representation of selected functional modules that may be included in processing module 101 is presented. Each of the modules 202 through 210 in the depicted representation may be implemented as software where the software includes instructions, executable by processing module 101, stored in a computer readable medium such as storage 104. As depicted in FIG. 2, storage 104 of device 100 may includes an accumulated dose module, a POL module 204, a TTL module 206, a set of programmable parameters 208, and an expected exposure level module 210.

Accumulated dose module 202 preferably includes code that, when executed, effectively integrates the radiation signal 125 over time to produce an estimate of a cumulative value of radiation exposure. Predicted exposure level module 210 preferably includes code that when executed produces a value representing a predicting level of radiation exposure. The predicted level of exposure may be derived, for example, as the average value of instantaneous exposure experienced during a specific time interval. Predicted exposure level module 210 may also employ other formulae or functions for predicting the exposure level.

POL module 204 includes software code that, when executed, is operable to retrieve an appropriate exposure threshold from programmable parameters 208 and to retrieve from accumulated dose module 202 the cumulative exposure value. POL module 204 then divides the cumulative dose value by the exposure threshold to determine the percentage of a threshold level radiation that a user has experienced. TTL module 206 preferably includes code that when executed determines how much time a user has until the user's exposure exceeds a specified threshold. In one embodiment, for example, TTL module 206 first determines the difference between the exposure threshold and the cumulative exposure value provided by accumulated dose module 202. This difference is then divided by the predicted level of exposure to derive a TTL value.

The POL value and the TTL value are then provided to display 110 of device 100 to generate a display that includes either the POL value, the TTL value, or both. Referring to FIG. 3, for example, an exemplary display device 110 suitable for use in device 100 is depicted. The depicted display 110 includes a mode indicator 302, a mode selector 304, an instantaneous gauge 306, an instantaneous range indicator 308, and an instantaneous exposure level window 310. In addition, the depicted embodiment of display 110 includes a POL window 320 and a TTL window 330.

Instantaneous gauge 306 as depicted includes a set of LED's or other visually detectable elements where each illuminated element represents an additional quantum of radiation exposure. The amount of exposure represented by each element in gauge 306 is indicated in range indicator 308, while the actual exposure level is indicated in window 310. The mode indicator 302 indicates the application or environment in which device 100 is being used. The available modes may includes a set of modes representing various levels of emergency or disaster. In the depicted embodiment, the mode is hand selectable using mode selector 304. In some embodiments, the various modes correspond to various exposure thresholds such that, for example, a first mode corresponds to a first exposure threshold while a second mode corresponds to a second threshold. The ability to accommodate multiple modes of operation beneficially enables the use of a first set of exposure thresholds during an event characterizable as relatively low risk or low damage and to use a second set of exposure thresholds during a relatively higher risk or higher damage.

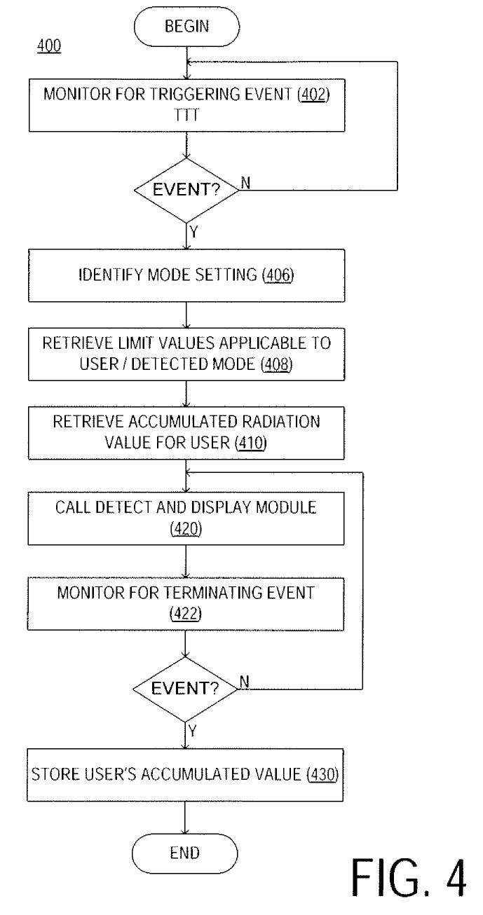

Turning now to FIG. 4, a flow diagram depicted an embodiment of a method 400 for detecting radiation. In some embodiments, the functionality represented by method 400 is implemented as software stored, for example, in storage 104. In the depicted embodiment of method 400, device 100 monitors (block 402) for a triggering event to initiate operation. The triggering event could be a power on sequence, an indication of a reset by the user, including, as an example, the activation of reset button 103, a change of mode by the user, or the like. Upon detecting a triggering event (block 404), method 400 proceeds.

In block 406, method 400 identifies the setting indicated in mode indicator 302 and retrieves (block 408) exposure thresholds and/or other limits and parameters applicable to the indicated mode. After retrieving the applicable exposure thresholds, the depicted implementation of method 400 includes retrieving an accumulated radiation value for the user. This embodiment is suitable for use in which a user may be removed from the radiation causing environment for a period of time. If the period is less than a specified minimum, it may be desirable to maintain any previous exposure, in which case, the previous exposure is accounted for by retrieving the accumulated radiation value applicable to the user. After retrieving exposure thresholds and prior exposure data, method 400 calls (block 420) a detect and display module.

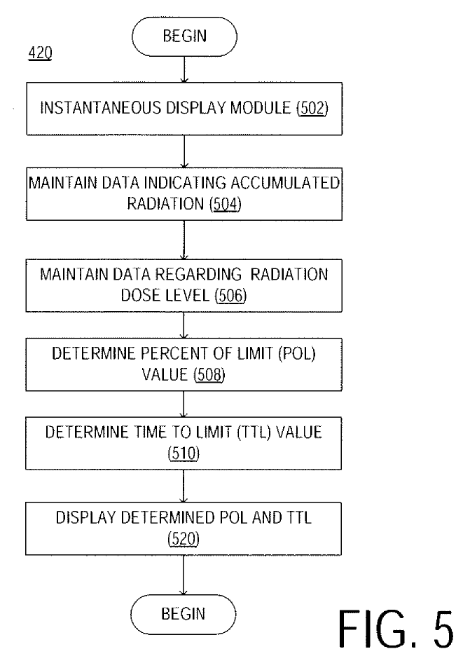

Referring to FIG. 5, the depicted embodiment of detect and display module 420 includes activating (block 502) the instantaneous display module to display the instantaneous levels of radiation to the user. Detect and display module 420 as depicted further includes maintaining data (block 504) that indicates the accumulated radiation level and maintaining (block 506) data regarding the instantaneous radiation dose level. The accumulated radiation value may be determined by integrating the instantaneous signal over time or implementing a digital approximation of integration. The maintenance of radiation dose level may be used to make a meaningful prediction of expected radiation dose level.

Detect and display module 420 as depicted further includes determining (block 508) the POL and determining (block 510) the TTL. The determined POL and TTL are then displayed (block 520). Although FIG. 3 and FIG. 5 described the determination of the POL value and the TTL value, other embodiments may use just one of these parameters.

Returning to FIG. 4, method 400 resumes operation after calling module 420 by monitoring (block 422) for a termination event. The termination event may be a power off, reset, or other user initiated event. Alternatively, a terminating event might be communicated wirelessly in embodiments where device 100 includes, for example, a wireless transceiver. If no terminating event is detected, method 400 returns to block 420 and re-executes the detect and display module 420. If a terminating event is detected, method 400 stores the user's accumulated exposure values in storage for possible future use if or when the user later enters the same environment or a different radiation emitting environment.

Those of ordinary skill in the field of radiation hazards and radiation monitoring will appreciate that an apparatus and associated technique for monitoring and reporting radiation exposure using time to limit or percent of limit parameters has been disclosed. The implementations and embodiments depicted in the drawings and described in the accompanying text are exemplary, but not exhaustive, of the scope of embodiments covered by the following claims.

What is claimed:

1. A dosimeter, comprising:
a display;
a processing resource;
a storage resource accessible to the processing resource;
a radiation detector operable to produce a signal indicative of an instantaneous radiation level in proximity to the dosimeter;
a module accessible to the processing resource and operable to determine an accumulated exposure from the instantaneous radiation signal;
a module to generate and display information based on the accumulated exposure;
wherein the displayed information includes information indicative of a parameter selected from the set of parameters consisting of a percentage of limit (POL) parameter and a time to limit (TTL) parameter;
wherein the POL parameter is indicative of a ratio of an accumulated exposure dose to an exposure threshold; and
wherein the TTL parameter is indicative of an amount of time estimated until the accumulated exposure exceeds the exposure threshold.

2. The dosimeter of claim 1, wherein the display includes information indicative of the POL parameter and the TTL parameter.

3. The dosimeter of claim 1, wherein the display further includes information indicative of the instantaneous radiation level.

4. The dosimeter of claim 3, wherein the display further includes information a graphical representation of the instantaneous exposure level.

5. The dosimeter of claim 4, wherein the graphical representation comprises a set of LED's arranged substantially in a line, wherein a number of activated LED's are indicative of the instantaneous exposure level.

6. The dosimeter of claim 5, wherein the display further includes an indication of a scale of the graphical representation.

7. The dosimeter of claim 1, further comprising a switch operable to select an operational mode of the dosimeter, wherein the POL parameter and the TTL parameter are determined in part by the operational mode.

8. A dosimeter including a radiation detector and a display, wherein the radiation detector is operable to output a signal indicative of an instantaneous radiation level and wherein the dosimeter is operable to determine and display a parameter selected from the parameters consisting of a percent of limit (POL) value and a time to limit (TTL) value, wherein the POL parameter is indicative of a ratio of an accumulated exposure to an exposure threshold and wherein the TTL parameter is indicative of an amount of time estimated until the accumulated exposure exceeds the exposure threshold

9. The dosimeter of claim 8, wherein the display includes information indicative of the POL parameter and the TTL parameter.

10. The dosimeter of claim 8, wherein the display further includes information indicative of the instantaneous radiation level.

11. The dosimeter of claim 10, wherein the display further includes information a graphical representation of the instantaneous exposure level.

12. The dosimeter of claim 11, wherein the graphical representation comprises a set of LED's arranged substantially in a line, wherein a number of activated LED's are indicative of the instantaneous exposure level.

13. The dosimeter of claim 12, wherein the display further includes an indication of a scale of the graphical representation.

14. The dosimeter of claim 8, further comprising a switch operable to select an operational mode of the dosimeter, wherein the POL parameter and the TTL parameter are determined in part by the operational mode.

15. A service enabling a user to monitor radiation exposure, comprising: providing a dosimeter, wherein the dosimeter includes:
a radiation detector operable to produce an output indicative of an instantaneous radiation level proximal to the radiation detector;
a processing module configured to receive the radiation detector output and operable to determine a percent of limit (POL) value and a time to limit (TTL) value;
wherein the POL value is indicative of an accumulated radiation exposure to an exposure threshold; and
wherein the TTL value is indicative of an amount time estimated until the accumulated radiation exposure exceeds the exposure threshold.

16. The service of claim 15, wherein the display further includes information indicative of the instantaneous radiation level.

17. The service of claim 16, wherein the display further includes information a graphical representation of the instantaneous exposure level.

18. The service of claim 17, wherein the graphical representation comprises a set of LED's arranged substantially in a line, wherein a number of activated LED's are indicative of the instantaneous exposure level.

19. The service of claim 18, wherein the display further includes an indication of a scale of the graphical representation.

20. The service of claim 15, further comprising a switch operable to select an operational mode of the dosimeter, wherein the POL parameter and the TTL parameter are determined in part by the operational mode.
